(19) United States
(12) Patent Application Publication
(10) Pub. No.: US 2016/0225266 A1
(43) Pub. Date: Aug. 4, 2016

(54) SYSTEM FOR MONITORING A-SMGCS IN REAL-TIME

(71) Applicant: LSIS CO., LTD., Gyeonggi-do (KR)

(72) Inventors: Ho-young Kang, Gyeonggi-do (KR); Seok-Chan Lee, Gyeonggi-do (KR); Tae-Weon Kim, Gyeonggi-do (KR)

(21) Appl. No.: 15/014,295

(22) Filed: Feb. 3, 2016

(30) Foreign Application Priority Data
Feb. 3, 2015 (KR) 10-2015-0017016

(51) Int. Cl. G08G 5/00; G08G 5/06

(52) U.S. Cl. CPC G08G 5/0073; G08G 5/065

(57) ABSTRACT

The present disclosure relates to a monitoring technique for an Advanced-Surface Movement Guidance and Control Systeni (A-SMGCS) in real time. In the system for monitoring the A-SMGCS, which comprises the A-SMGCS and a high-level device for monitoring the A-SMGCS, an A-SMGCS server includes a monitoring module and a plurality of information transmit modules, each of which has its own status information and action information, and the monitoring module receives status information and action information sent from the plurality of information transmit modules and transmits them to the high-level device in real time.

### CROSS REFERENCE TO RELATED APPLICATION

This application claims the benefit of Korean Patent Application No. 10-2015-0017016, filed on Feb. 3, 2015, which is hereby incorporated by reference in its entirety into this application.

### BACKGROUND

1. Technical Field

The present disclosure relates to a monitoring technique for an Advanced-Surface Movement Guidance and Control System (A-SMGCS), and more particularly, to a system capable of monitoring the A-SMGCS in real time.

2. Description of the Related Art

According to a SMGCS (Doc 9476-AN/927) which is a manual of International Civil Aviation Organization (ICAO), an A-SMGCS is defined as a system having routing, guidance and surveillance functions for the control of aircrafts and vehicles in order to maintain the declared surface movement rate under all weather conditions within the airfield visibility operational level while maintaining the target level of safety.

That is, the A-SMGCS indicates a system related to equipment, procedures and supporting facilities designed to satisfy guidance and control requirements of ground traffics coincident to any specific operational conditions at any specific airfield, and is composed of a visual aided facility, a non-visual aided facility, a radio communication facility, a procedure-control-information associated facility or equipment, and the appropriated combination thereof.

The main reason of needing the A-SMGCS is to safely operate an airfield under a designated condition. The A-SMGCS may provide any specific weather condition, a sufficient capacity relevant to a traffic density and an airfield positioning, and a safety through an employment of up-to-date technique and a high level consolidation of various functions, and may increase a low visibility operation and an airfield capacity of a complex and high dense airfield through a usefulness and advancement of a new technology including an automatic performance.

The A-SMGCS consists of various modules according to respective functions. The respective modules include status information and action information acquired while performing their operations and integrate and store thereon such status information and action information from the respective modules.

When a request for the monitoring of the A-SMGCS is sent ab extra, the A-SMGCS provides the integrated and stored information.

Referring to FIG. 1, a conventional monitoring system 100 for monitoring the A-SMGCS is composed of an A-SMGCS server 110 and a high-level device 120.

The A-SMGCS server 110 gathers and stores various information generated while operating according to the functions and sends the requested information to the high-level device 120. When the high-level device 120 requests information, the high-level device receives the information sent from the A-SMGCS server 110 and then updates and displays the information.

At this time, the A-SMGCS server 110 includes a surveillance module 111, control module 112, a routing module 113, a guidance module 114 and a monitoring module 115 classified by functions.

The surveillance module 111, the control module 112, the routing module 113 and the guidance module 114 respectively contain status information and action information. The status information is log data related to current status of the modules and the action information is log data generated while the modules perform any specific tasks.

The respective modules 111, 112, 113 and 114 send the information to the monitoring module 115 whenever status log and operation log occur.

The monitoring module 115 gathers the status information and the action information from the respective modules 111, 112, 113 and 114 and stores such information on a storage 115a, and when the high-level device 120 requests information, sends the requested information to the high-level device 120.

At this time, the high-level device 120 periodically requests information from the monitoring module 115 to update and display the information about the A-SMGCS.

According to such a conventional technique, because the high-level device 120 periodically requests information, it takes for information generated from the respective modules 111, 112, 113 and 114 to be stored on the storage 115a and a delay occurs by a period of the request. This delay causes a problem of degrading a Mission Critical system such as the A-SMGCS, which has to ensure the determinism.

Further, the high-level device 120 connects to the A-SMGCS server 110 to request information every period without respect to the presence or update of the information and hence unnecessarily uses a CPU of the high-level device 120. Therefore, such a conventional technique results in a resource waste.

In addition, although the CPU of the high-level device 120 has to process a scheduled task, due to the request for information to the A-SMGCS server 110, it may not process to delay the scheduled task in time, thereby resulting in ineffectiveness.

Moreover, in order to use the conventional technology in near-real time, the period of requesting information has to set to be very short, but such, a short period may result in a network bandwidth waste.

### SUMMARY

Therefore, to address the above problems, an object of embodiments in the present disclosure is to provide a system capable of monitoring information on the A-SMGCS in real time.

In view of the above, an object of embodiments in the present disclosure is to provide a system for monitoring the A-SMGCS, which comprises the A-SMGCS and a high-level device for monitoring the A-SMGCS, wherein the server of the A-SMGCS includes a monitoring module and a plurality of information transmit modules, each of which has status information and action information, and the monitoring module receives the status information and action information sent from the plurality of information transmit modules and transmits them to the high-level device in real time.

In some embodiments, the plurality of information transmit modules may include a surveillance module, a control module, a routing module and a guidance module.

In some embodiments, each of the plurality of information transmit modules transmits its own status information and action information to the monitoring module in real time when the own status information and action information are generated or changed.

In some embodiments, the log manager receives and stores thereon the status information sent from the plurality of information transmit modules, sends the status information and action information to the high-level device, and sends the status information to the status manager, and the status manager stores thereon the status information sent from the log manager.

In some embodiments, the high-level device sends a request for the status information to the status manager when it is determined that the status information is needed.

In some embodiments, the status manager, upon receiving the request for the status information from the high-level device, determines whether the status information stored thereon is normally stored status information, and if so, sends the status information to the high-level device.

In some embodiments, on the other hand, if it is determined that the status information stored on the status manager itself is not normally stored status information, the status manager sends a request for the status information to the plurality of information transmit modules, receives the status information sent from the plurality of information transmit modules, and sends the received status information to the high-level device.

In some embodiments, meanwhile the status information is sent in a form of a packet, and the packet is assigned a serial number field, a host name field, a program name field, a module name field, a status information count field, and status information fields in this order.

In some embodiments, further, the action information is sent in a form of a packet, wherein the packet is assigned a serial number field, a host name field, a program name field, a module name field, an action information count field, and action information fields in this order.

According to such a configuration of some embodiments of the present disclosure, the status information and action information are gathered from various modules in the server in real time and sent to the high-level device, and hence the high-level device may monitor the A-SMGCS in real time.

Further, the conventional technique achieves the sending of information by a polling scheme, whereas the present disclosure achieves the sending of information at the time point when an event occurs. Therefore, embodiments of the present disclosure perform the sending of information only in case of need and thus needs not to unnecessarily use a CPU of the high-level device, thereby enabling the CPU to efficiently be used.

In addition, the conventional technique employs a manner that the high-level device periodically requests information from the server in the A-SMGCS and thus exhibits a problem of excessively using a network resource. However, embodiments of the present disclosure achieve the sending of information at the time point when an event occurs and as a result may prevent the network resource from unnecessarily being used.

### BRIEF DESCRIPTION OF DRAWINGS

FIG. 1 is a block diagram of a conventional monitoring system for monitoring a A-SMGCS;

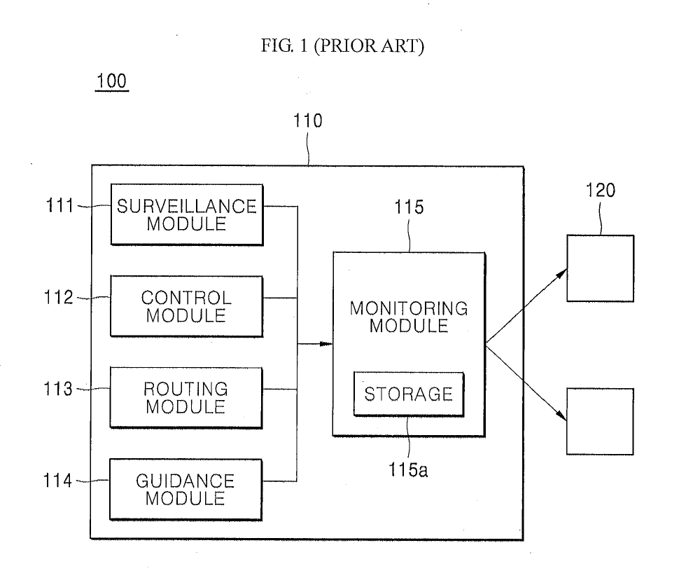

FIG. 2 is a block diagram of a real time monitoring system for monitoring an A-SMGCS in real time according to an embodiment of the present disclosure;

FIG. 3 is a diagram illustrating a form of a packet for status information sent from an A-SMGCS server according to an embodiment of the present disclosure;

FIG. 4 is a diagram illustrating a form of a packet for action information sent from the A-SMGCS server according to an embodiment of the present disclosure;

FIG. 5 is a flowchart illustrating a process of a first operation in a real time monitoring system for monitoring an A-SMGCS in real time according to an embodiment of the present disclosure; and

FIG. 6 is a flowchart illustrating a process in a second operation in a real time monitoring system for monitoring the A-SMGCS in real time according to an embodiment of the present disclosure.

### DETAILED DESCRIPTION

Advantages and features of the present disclosure and methods to achieve them will become apparent from the descriptions of exemplary embodiments herein below with reference to the accompanying drawings. However, the present disclosure is not limited to exemplary embodiments disclosed herein but may be implemented in various different ways. The exemplary embodiments are provided for making the disclosure of the present disclosure thorough and for fully conveying the scope of the present disclosure to those skilled in the art. It is to be noted that the scope of the present disclosure is defined solely by the claims. Like reference numerals denote like elements throughout the descriptions.

Detailed descriptions of well-known functions and structures incorporated herein will be omitted to avoid obscuring the subject matter of the present disclosure. Terms described below are defined in the light of functions in embodiments of the present disclosure and may vary depending on a user, an operator's intent, a practice or the like. Therefore, the terms should be defined based on the content of the disclosure throughout the specification.

Hereinafter, a system and method for monitoring an A-SMGCS in real time according to the embodiments of the present disclosure will be described with reference to the accompanying drawings.

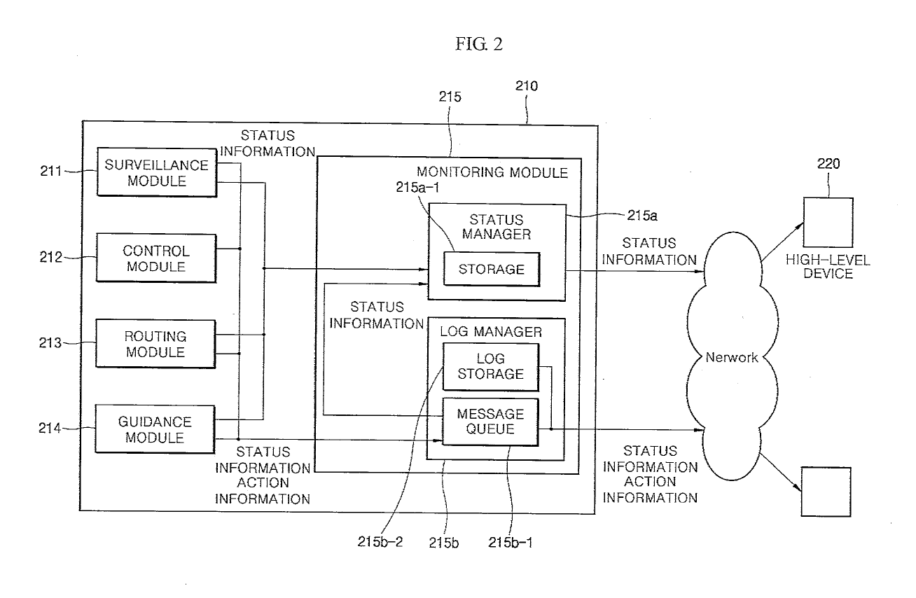

FIG. 2 is a block diagram of a real time monitoring system for monitoring an A-SMGCS in real time according to an embodiment of the present disclosure.

Referring to FIG. 2, the real time monitoring system for monitoring the A-SMGCS in real time (hereinafter, ‘monitoring system’) is composed of a A-SMGCS server 210 and a high-level device 220, wherein the high-level device 220 may include all devices provided information from the A-SMGCS server 210.

The A-SMGCS server 210 includes a plurality of modules 211, 212, 213 and 214 classified by respective functions. The A-SMGCS server 210 gathers information generated from the respective modules 211, 212, 213 and 214 and sends such information to the high-level device 220 in real time.

Further, when the high-level device 220 requests information, the A-SMGCS server 210 sends the stored information to the high-level device 220 or gathers information from the plurality of modules 211, 212, 213 and 214 to send such information to the high-level device 220.

The high-level device 220 receives information sent from the A-SMGCS server 210 to monitor the A-SMGCS, and requests the sending of information from the A-SMGCS server 210 if necessary.

In this case, the high-level device 220 requests the sending of information from the A-SMGCS server 210 when it connects to the A-SMGCS server 210 for the first time or when the requested information is not sequential (for example, a serial number of the information is not sequential, a time point when the information has been generated is not sequential).

At this time, the A-SMGCS server 210 and the high-level device 220 may transmit/receive information using various known and in-use various wire/wireless communication networks.

Referring to FIG. 2, a configuration and function of the A-SMGCS server 210 according to the embodiment of the present disclosure will be described in more detail.

The A-SMGCS server 210 includes a surveillance module 211, control module 212, a routing module 213, a guidance module 214 and a monitoring module 215 classified by respective functions.

The surveillance module 211, the control module 212, the routing module 213 and the guidance module 214 respectively have status information and action information. The status information is log data related to current status of the modules and the action information is log data generated while the modules operate according to their respective functions.

Each of the modules 211, 212, 213 and 214 generates its own status information and action information, and provides the status information or action information to the monitoring module 215 in real time.

The ‘real time’ refers to every time point when the status information and action information of the modules 211, 212, 213 and 214 are generated, wherein ‘generation’ of information covers both a new creation of the information and a change of the information.

The monitoring module 215 is provided with and stored thereon the status information and action information from the modules 211, 212, 213 and 214, while it sends the stored information to the high-level device 220.

The monitoring module 215 may be implemented to be provided with the status information and action information from the modules 211, 212, 213 and 214 in real time.

Further, the monitoring module 215 may be implemented to request information from the modules 211, 212, 213 and 214 and then be provided with the status information from the modules 211, 212, 213 and 214.

The monitoring module 215 may request information from the modules 211, 212, 213 and 214 in response to a request from the high-level device 220.

The monitoring module 215 includes a status manager 215a and a log manager 215b.

The status manager 215a includes a status storage 215a-1 to store thereon the status information from the modules 211, 212, 213 and 214.

The status manager 215a sends the status information stored on the status storage 215a-1 to the high-level device 200 when a request for information is received from the high-level device 200.

The status manager 215a may store status information sent from the log manager 215b. Further, the status manager 215a may directly request status information from the modules 211, 212, 213 and 214 to store thereon the status information sent from the 211, 212, 213 and 214 in response.

The status manager 215a may be implemented to send status information stored thereon to the high-level device 220 when it is determined that the status information stored on the status manager 215a itself is normally stored status information, and when it is determined that the status information stored thereon is not the normally stored status information, request and receive status information from the modules 211, 212, 213 and 214 to send the received status information to the high-level device 220.

In this case, the status manager 215a determines whether a serial number of the stored status information is sequential, and if so, determines that the status information has been normally stored.

On the contrary, the status manager 215a determines whether a serial number of the stored status information is not sequential, and if not so, determines that the status information has been abnormally stored.

The log manager 215b receives and stores thereon the status information and action information sent from the modules 211, 212, 213, 214, sends the status information and action information to the high-level device 220, and sends the status information to the status manager 215a.

The log manager 215b includes a message queue 215b-1 and a log storage 215b-2. The log message queue 215b-1 receives the status information and action information sent from the modules 211, 212, 213 and 214, sends the status information and action information to the log storage 215b-2 and the high-level device 220, and sends the status information to the status manager 215a.

The log storage 215b-2 stores thereon the status information and action information sent from the message queue 215b-1.

Now the modules 211, 212, 213 and 214 are described in detail. The surveillance module 211, which is a module for surveilling a location of an aircraft in an airport, may check aircrafts, vehicles and unauthorized objects within a movement area, identify locations of them, use labels (colors) and symbols to distinguish a take-off aircraft and a landing aircraft, and identify moving directions of such aircrafts.

Examples of identification information from the surveillance module 211 may include, e.g., coordinate information updated every 1 second for moving objects within the movement area, and examples of action information from the surveillance module 211 may include a manual labeling of an aircraft by an air controller.

The control module 212, which is a module for providing an alert and controlling a moving object (an aircraft, a vehicle, etc.) on the ground under a control of the air controller for preventing accidents when an abnormal situation occurs, may control an aircrafts/vehicles collision, a route deviation, a runway incursion, etc, and control a movement or stop/a spaced distance of an aircraft/vehicle by a control of STB lights (Stop Bar Lights).

Examples of the status information from the control module 212 may include an assigned status of a responsible control area at a taxiway/runway and examples of the action information from the control module 212 may include an aircrafts collision alarm, a route deviation alarm, etc.

The routing module 213, which is a module for automatically setting a route along which an aircraft moves, may set the route for safe and quick movement of the aircraft within the movement area.

Examples of the status information from the routing module 213 may include route information of the take-off aircraft and the landing aircraft at this point in time and examples of the action information of the routing module 213 may include a calculation for an optimal route of any specific aircraft under a control of the air controller or the monitoring system.

The guidance module 214, which is a module for controlling ground lights to guide an aircraft, may provide continuous and reliable information about a route assigned to an aircraft/vehicle and provide continuous information about an aircraft movement route on ground in conjunction with TCLLs (Taxiway Centerline Lights), TEDLs (Taxiway Edge Lights), TGSs (Taxiway Guidance Signs), ASMGLs (Aircraft Stand Manoeuvring Guidance Lights), VDGS (Visual Docking Guidance System).

Example of the status information from the guidance module 214 may include

lighting status of an apron, a taxiway and a runway at this point in time and examples of the action information from the guidance module 214 may include a turning-on of lights arranged in front of the moving aircraft and a turning-off of lights arranged at the rear of the moving aircraft.

Although main functions, status information and action information of the surveillance module 211, the control module 212, the routing module 213 and the guidance module 214 have been described above, they are merely illustrated by way of example for illustrating the A-SMGCS and the present disclosure is not limited thereto.

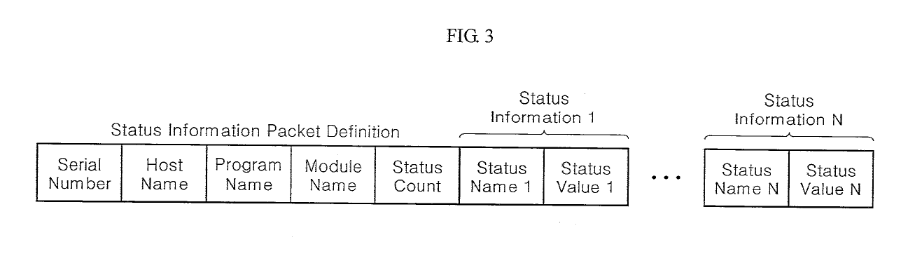

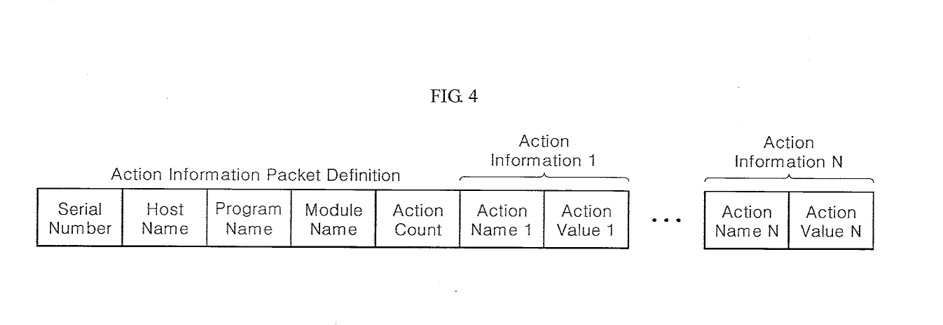

FIG. 3 is a block diagram illustrating a form of a packet for sending status information sent from the A-SMGCS server according to an embodiment of the present disclosure, and FIG. 4 is a block diagram illustrating a form of a packet for action information sent from the A-SMGCS server according to an embodiment of the present disclosure.

Referring to FIG. 3, the status information packet is assigned a serial number field, a host name field, a program name field, a module name field, a status count field, and status information fields in this order.

Each of the status information fields consists of a pair of a status name field and a status value field, and the status information fields are provided as much as a status count indicated in the status count field.

Referring to FIG. 4, the action information packet is assigned a serial number field, a host name field, a program name field, a module name field, an action count field, and action information fields in this order.

Each of the action information fields consists of a pair of an action name field and an action value field, and the action information fields are provided as much as an action count indicated in the action count field.

Heretofore, the configuration and function of the monitoring system according to the embodiment of the present disclosure have been described. Hereinafter, detailed operations of the monitoring system having the configuration as shown in FIG. 2 will be described in steps with reference to the accompanying drawings.

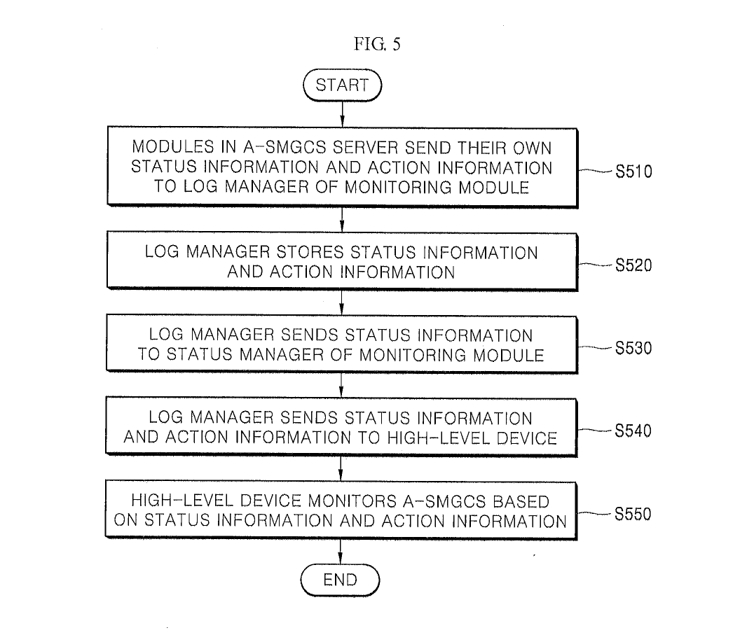

FIG. 5 is a flowchart illustrating a process in a first operation of a real time monitoring system for monitoring the A-SMGCS according to an embodiment of the present disclosure.

Referring to FIG. 5, for the plurality of modules 211, 212, 213 and 214 in the A-SMGCS server 210, when their own status information and action information are generated or changed, they send the status information and action information to the log manager 215h of the monitoring module 215 in the A-SMGCS server 210 (S510).

Next, the log manager 215b having received the status information and action information sent from the plurality of modules 211, 212, 213 and 214 in step S510 stores thereon the received status information and action information (S520), sends the status information to the status manager 215a of the monitoring module 215 (S530), and sends the status information and action information to the high-level device 220 (S540).

The steps that the log manager 215b stores thereon the received status information and action information (S520), sends the status information to the status manager 215a (S530), and sends the status information and action information to the high-level device 220 (S540) may be sequentially executed as in the embodiment of the present disclosure but the order of the steps may be modified and be executed in parallel.

Then, the high-level device 220 having received the status information and action information sent from the log manager 215b in step S540 monitors the A-SMGCS based on the received status information and action information (S550).

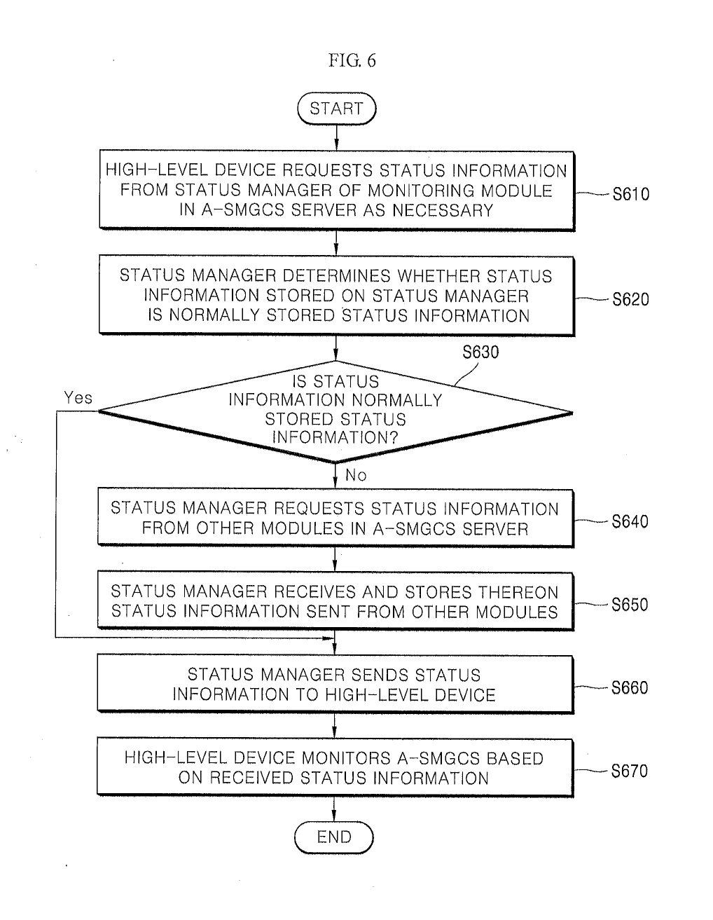

FIG. 6 is a flowchart illustrating a process in a second operation of a real time monitoring system for monitoring the A-SMGCS according to an embodiment of the present disclosure.

Referring to FIG. 6, the high-level device 220 requests the status information from the status manager 215a of the monitoring module 215 in the A-SMGCS server 210 as necessary (S610).

The high-level device 220 may request status information from the status manager 215a when it connects to the A-SMGCS server 210 for the first time or when the received information is not sequential (for example, a serial number of the received information is not sequential, a time point that the received information has been generated is not sequential).

The status manager 215a having received the request for the status information determines whether the status information stored on the status manager 215a itself is normally stored status information (S620 and S630).

If it is determined that status information stored on the status manager 215a is normally stored status information (S630—Yes), the status manager 215a sends the stored status information to the high-level device 220 (S660).

On the other hand, if otherwise it is determined that the status information stored on the status manager 215a is not normally stored status information (S630—No), the status manager 215a requests status information from the other modules 211, 212, 213 and 214 in the A-SMGCS server 210 (S640), and receives and stores thereon the status information sent from the other modules 211, 212, 213 and 214 (S650).

Thereafter, the status manager 215b sends the status information received from the other modules 211, 212, 213 and 214 to the high-level device 220 (S660), and the high-level device 220 monitors the A-SMGCS based on the received status information (S670).

According to such a configuration of embodiments of the present disclosure, the status information and action information are gathered from various modules in the A-SMGCS server in real time and sent to the high-level device, and hence the high-level device may monitor the A-SMGCS in real time.

Further, the conventional technique employs a polling scheme to send information, whereas embodiments of the present disclosure achieve the sending of information at the time point when an event occurs to perform the sending of information only in case of need and thus needs not to unnecessarily use a CPU of the high-level device, thereby enabling the CPU to efficiently be used.

In addition, the conventional technique operates such that the high-level device periodically requests information from the A-SMGCS server and thus exhibits a problem of excessively using a network resource. However, embodiments of the present disclosure achieve the sending of information at the time point when an event occurs and as a result may prevent the network resource from unnecessarily being used.

While the real time monitoring system and method for monitoring the A-SMGCS in real time have been described with respect to the embodiments of the present disclosure, the present disclosure is not limited to any particular embodiments and the present disclosure described above may be variously substituted, altered, and modified by those skilled in the art without departing from the scope and spirit of the present disclosure.

Therefore, the embodiments described in the present disclosure and the accompanying drawings are presented for purposes of illustrating the technical spirit of the present disclosure, not in a sense of limitation, and the scope of the present disclosure is not limited to such embodiments and the accompanying drawings. The scope of the subject matter is defined only by the appended claims, appropriately interpreted, along with the full range of equivalents to which the appended claims are entitled.

What is claimed is:

1. A system for monitoring an Advanced-Surface Movement Guidance and Control System (A-SMGCS) in real time, the system comprising the A-SMGCS and a high-level device for monitoring the A-SMGCS,
wherein an A-SMGCS server includes a monitoring module and a plurality of information transmit modules, each of which has its own status information and action information, and
wherein the monitoring module receives the status information and the action information sent from the plurality of information transmit modules and transmits them to the high-level device in real time.

2. The system according to claim 1, wherein the plurality of information transmit modules includes a surveillance module, a control module, a routing module and a guidance module.

3. The system according to claim 1, wherein each of the plurality of information transmit modules transmits its own status information and action information to the monitoring module in real time when the status information and the action information are generated or changed.

4. The system according to claim 1, wherein the monitoring module includes a log manager and a status manager,
wherein the log manager receives and stores thereon the status information sent from the plurality of information transmit modules, sends the status information and the action information to the high-level device, and sends the status information to the status manager, and
wherein the status manager stores thereon the status information sent from the log manager.

5. The system according to claim 4, wherein the high-level device sends a request for the status information to the status manager when it is determined that the status information is needed.

6. The system according to claim 5, wherein the status manager, upon receiving the request for the status information from the high-level device, determines whether the status information stored thereon is the normally stored status information, and if so, sends the status information to the high-level device.

7. The system according to claim 6, wherein the status manager, upon determining that the status information stored thereon is not the normally stored status information, sends a request for the status information to the plurality of information transmit modules, receives the status information sent from the plurality of information transmit modules, and sends the received status information to the high-level device.

8. The system according to claim 1, wherein the status information is sent in a form of a packet, and
wherein the packet is assigned a serial number field, a host name field, a program name field, a module name field, a status information count field, and status information fields in this order,

9. The system according to claim 1, wherein the action information is sent in a form of a packet, and
wherein the packet is assigned a serial number field, a host name field, a program name field, a module name field, an action information count field, and action information fields in this order.
